(19) United States
(12) Patent Application Publication
(10) Pub. No.: US 2013/0091546 A1
(43) Pub. Date: Apr. 11, 2013

(54) Transmitting Authentication Information

(71) Applicants: Jiadong Shen, Munchen (DE); Ulrich Wiehe, Bad Hersfeld (DE)

(72) Inventors: Jiadong Shen, Munchen (DE); Ulrich Wiehe, Bad Hersfeld (DE)

(73) Assignee: Nokia Siemens Networks Oy, Espoo (FI)

(21) Appl. No.: 13/704,669

(22) PCT Filed: Jun. 18, 2010
(86) PCT No.: PCT/EP2010/058649

§ 371 Date: Dec. 17, 2012

(51) Int. Cl. H04L 29/06

(52) U.S. Cl. CPC H04L 63/08
USPC 726/3

(57) ABSTRACT

The invention relates to a session control entity, a subscriber data entity, method and a computer program product for registering a user to a network, obtaining authentication information for the user and transmitting the authentication information to a subscription entity of the network during a registration of the user.

### TECHNICAL FIELD OF THE INVENTION

The present invention relates to a mechanism for transmitting authentication information. In particular, the present invention is related to a method and apparatus for transmitting authentication information between a session control entity and a subscription entity.

### BACKGROUND OF THE INVENTION

Within the IP (Internet Protocol) Multimedia Subsystem (IMS) as defined by 3^{rd} Generation Partnership Project (3GPP) Session Initiation Protocol (SIP) defined by Internet Engineering Task Force (IETF) is used for controlling communication. SIP is an application-layer control protocol for creating, modifying, and terminating sessions with one or more participants. These sessions may include Internet multimedia conferences, Internet telephone calls, and multimedia distribution. Members in a session can communicate via multicast or via a mesh of unicast relations, or a combination of these. Session Description Protocol (SDP) is a protocol which conveys information about media streams in multimedia sessions to allow the recipients of a session description to participate in the session. The SDP offers and answers can be carried in SIP messages. Diameter protocol has been defined by IETF and is intended to provide an Authentication, Authorization and Accounting (AAA) framework for applications such as network access or IP mobility.

Generally, for properly establishing and handling a communication connection between network elements such as a user equipment and another communication equipment or user equipment, a database, a server, etc., one or more intermediate network elements such as control network elements, support nodes, service nodes and interworking elements are involved which may belong to different communication networks.

The 3GPP defines IMS restoration procedure for serving call state control function (S-CSCF), so that an IMS service can be provided for IMS users after an S-CSCF restart or S-CSCF failure. In the restoration procedure, an S-CSCF can backup to a home subscriber server (HSS) registration and service related information and later restore the same information from the HSS.

Normally this way also originating SIP request can be served by a restarted S-CSCF, by restoring the registration related information from the HSS, which was uploaded by the S-CSCF to the HSS during registration procedure. However, when multiple authentication schemes are supported an S-CSCF cannot know whether it can trust the received request or not and how to authenticate the user sending the requests, when handling originating requests after the S-CSCF restart.

### SUMMARY OF THE INVENTION

The present invention overcomes above drawbacks by providing an apparatus, a method and a computer program product comprising registering or initiating a registration of a user to a network, obtaining authentication information to authenticate the user or for the user, and, transmitting the authentication information to a subscription entity of the network during a registration of the user.

The authentication information can be transmitted with call state control function (S-CSCF) Restoration Information and the authentication information can be transmitted in {SIP-Auth-Data-Item} Attribute-Value-Pair (AVP).

The authentication information can include, for example, SIP-Authentication-Scheme and/or SIP-Digest-Authenticate parameters.

The apparatus, method and computer program product can comprise:
transmitting updated authentication information to the subscription entity of the network, and/or
receiving the authentication information from the subscription entity of the network, and/or
determining an authentication scheme used for authenticating the user, and/or,
transmitting the authentication information to the subscription entity depending on the used authentication scheme.

The apparatus, method and computer program product can comprise:
transmitting the authentication information when the used authentication scheme comprises SIP Digest authentication, and/or,
not to transmit the authentication information when the used authentication scheme comprises IMS AKA. Further, an apparatus, a method and a computer program product are provided, comprising receiving from a first session control entity authentication information during registration of a user, and transmitting the authentication information to the first or a second session control entity.

The apparatus, method and computer program product can comprise:
determining that a second session control entity is assigned to serve the user, and transmitting the authentication information to the second session control entity, and/or
storing the authentication information.
replacing at least part the authentication information with updated authentication information received from the first session control entity.

The storing can include storing the authentication information:

associated with an identity of the user, and/or

together with or as part of call state control function restoration information.

Further, an apparatus, a method and a computer program product are provided, comprising transmitting, by a first session control entity, authentication information to a subscription entity during a registration of a user, and, transmitting by the subscription entity the authentication information to the first or a second session control entity assigned to serve the user.

The apparatus, method and computer program product can comprise storing the authentication information at the subscription entity together with or as part of call state control function restoration information.

Further, an apparatus, a method and a computer program product are provided, comprising initiating registration of a user to a network, obtaining authentication information to authenticate the user, and, transmitting the authentication information to a subscription entity of the network during the registration of the user.

The apparatus, method and computer program product can comprise determining an authentication scheme used for authenticating the user and wherein the transmitting comprises to transmit the authentication information to the subscription entity depending on the used authentication scheme.

Further, an apparatus, a method and a computer program product are provided, comprising receiving from a first session control entity authentication information during a registration of a user, and transmitting the authentication information to the first or a second session control entity.

Embodiments of the present invention may have one or more of following advantages:

Enables an S-CSCF to provide originating services also before the next SIP REGISTER request of a user is handled.

No additional Cx transaction is needed for implementation, which means less performance impact.

### DESCRIPTION OF DRAWINGS

FIGS. 1 and 2 illustrate signalling between relevant network elements according to aspects of the invention.

FIGS. 3 and 4 illustrate examples of internal structure and functions of apparatuses implementing aspects of the invention.

FIG. 5 illustrate s an example process for implementing aspects of the invention.

### DETAILED DESCRIPTION OF THE INVENTION

Figure illustrates architecture of an IMS network. Different types of network entities and functions exist in the IMS network. Call Session Control Functions (CSCF) implement a session control function in SIP layer. The CSCF can act as Proxy CSCF (P-CSCF), Serving CSCF (S-CSCF) or Interrogating CSCF (I-CSCF). The P-CSCF is the first contact point for the User Equipment (UE) within the IMS; the S-CSCF handles the session states in the network; the I-CSCF is mainly the contact point within an operator's network for all IMS connections destined to a subscriber of that network operator, or a roaming subscriber currently located within that network operator's service area.

The functions performed by the I-CSCF are, for example, assigning an S-CSCF to a user performing a SIP registration and routing SIP requests received from another network towards the S-CSCF. The S-CSCF can perform the session control services for the UE. It maintains a session state as needed by the network operator for support of the services and may be acting as Registrar, i.e. it accepts registration requests and makes its information available through the location server (e.g. HSS). The S-CSCF is the central point to users that are hosted by this S-CSCF. The S-CSCF can provide services to registered and unregistered users when it is assigned to these users. This assignment can be stored in the Home Subscriber Server (HSS).

The HSS is the master database for a given user. It is the entity containing the subscription-related information to support the network entities actually handling calls/sessions. As an example, the HSS provides support to the call control servers (CSCFs) in order to complete the routing/roaming procedures by solving authentication, authorisation, naming/addressing resolution, location dependencies, etc. The HSS can be responsible for holding the following user related information:

User Identification, Numbering and addressing information

User Security information: Network access control information for authentication and authorization, such as password information

User Location information at inter-system level: the HSS supports the user registration, and stores inter-system location information, etc.

User profile information.

Cx reference point or Cx interface is an interface between a CSCF and a HSS, supporting the transfer of data between them. The Cx reference point is based on the diameter protocol with 3GPP standard diameter applications. Sh interface is a corresponding interface between the HSS and an AS. Diameter is an authentication, authorisation, and accounting (AAA) protocol defined by the IETF and used for network access services, such as dial-up and mobile IP. The Diameter base protocol is evolved from the remote authentication dial-in user service (RADIUS) protocol.

Diameter multimedia client and Diameter multimedia server implement the Diameter multimedia application. The client is one of the communicating Diameter peers that usually initiates transactions. Examples of communication elements that may implement the Diameter multimedia client are the I-CSCF and S-CSCF. An example of a Diameter multimedia server is the HSS.

Attribute-value pair (AVP) is a generic pair of values that consists of an attribute header and the corresponding value. The AVP can be used, for example, to encapsulate protocol-specific data such as routing information, as well as authentication, authorisation, or accounting information. Diameter messages can contain AVPs to transmit information between an I-CSCF and the HSS.

In an IMS registration with a CSCF, user equipment (UE) registers itself to a CSCF for a specific time, and the CSCF becomes the UE's serving CSCF (S-CSCF). The time for which the UE is registered in the CSCF is called registration lifetime.

In the IMS, the assignment of the S-CSCF takes place when the first SIP request for a user arrives at an S-CSCF. The S-CSCF then tries to download a user profile of the user from the HSS using Server-Assignment-Request (SAR). SAR request is a Diameter command message that a Diameter multimedia client can send to a Diameter multimedia server to request the server to store the name of the server (the S-CSCF) that is currently serving the user. The interface between the S-CSCF and the HSS is called Cx interface. If no S-CSCF is previously assigned to this user, the HSS can assign the S-CSCF to this user and provide the user profile to the S-CSCF using Diameter Server-Assignment-Answer (SAA) response over Cx interface.

User-Authorization-Request message (UAR) is a Diameter command message that a Diameter multimedia client can send to a Diameter multimedia server to request the authorisation of the registration of a multimedia user. User-Authorization-Answer message (UAA) is a Diameter command message that a server can send as a response to a previously received User-Authorization-Request message. The UAA can include a service profile of the user.

Cx interface exist between both the HSS and the I-CSCF, and the HSS and the S-CSCF. In order to support the S-CSCF selection described above and to allow the S-CSCF to perform its tasks, the Cx interface must support transferring following information:

transfer of CSCF-UE security parameters from HSS to CSCFs. The security parameters allow the CSCFs and the UE to communicate in a trusted and secure way.

transfer of service parameters of the subscriber from HSS to CSCFs. This may include e.g. service parameters, Application Server (AS) address, triggers, information on subscribed media etc. The information on subscribed media is provided in the form of a profile identifier; details of the allowed media parameters associated with the profile identifier are configured in the S-CSCF.

transfer of CSCF capability information from HSS to CSCFs. This may include e.g. supported service set, protocol version numbers etc.

transfer of session signalling transport parameters from CSCFs to HSS. The HSS stores the signalling transport parameters and they are used for routing mobile terminated sessions to the Serving-CSCF. The parameters may include e.g. IP-address and port number of CSCFs, transport protocol etc. The information mentioned above shall be transferred before the CSCF is able to serve the user. It shall also be possible to update this information while the CSCF is serving the user, for example if new services are activated for the user.

S-CSCF Restoration Information is information required for the S-CSCF to handle traffic for a registered user. This information is stored in HSS and if lost, retrieved by the S-CSCF.

IMS restoration information can contain information related to a specific registration required for an S-CSCF to handle requests for a user. For example, subscription information, list of SIP proxies in the path, contact address and parameters in the SIP Contact header of the registration request can be part of the restoration information stored in the HSS. Restoration information can be associated with a Private User Identity of the user and/or the IMS implicit registration set that is affected by the SAR request.

Service interruption is a period of time in which one or more network elements do not respond to requests and do not send any requests to the rest of the system, for example, an S-CSCF which is failing and restarting

Authentication procedure is confirmation of the claimed identity of a user. Authentication can be done, for example, with passwords or a user name, or by checking that the system is the one to which the user wishes to have a connection, for example a web site. Authentication can also involve the use of a cryptographic system and digital signatures. The party being authenticated can be a user, subscriber, home environment, or serving network.

IMS authentication and key agreement (IMS AKA) is an authentication protocol that is a part of the SIP-based registration procedure by which an IMS user is authenticated, and based on which an integrity key and a cipherkey are established for the protection of subsequent messages.

Hypertext transfer protocol (HTTP) digest authentication is authentication which verifies with a challenge-response mechanism that both parties to the communication know a shared secret, such as a password.

HTTP digest authentication can be done without sending the shared secret in clear. It can be used, for example, when IMS services are accessed with terminals that either do not have a SIM card or UMTS IC card (UICC) or cannot use the card in IMS authentication. SIP Digest authentication is similar to HTTP digest authentication.

NASS-IMS-bundled authentication (NBA) and GPRS-IMS-Bundled Authentication (GIBA) are other examples of authentication schemes.

When multiple authentication schemes are supported an S-CSCF cannot know whether it can trust the received request or not and how to authenticate the user sending the requests, when handling of originating requests after S-CSCF restart. One possible solution is to download authentication info from the HSS, i.e. via Cx-MAR request. But this is only applicable in a single authentication schema configuration, i.e. there is only a single authentication method applied by the S-CSCF. In this case, the S-CSCF can send a new Cx-MAR to download user credential from the HSS for the authentication. But here an additional Cx transaction is needed, which will have performance impact on the HSS and S-CSCF. Because it can be expected that so lot of S-CSCF restoration procedures run in parallel after an S-CSCF restart, such burst performance impact may affect the normal IMS operation (cause CSCF or HSS overload) and shall not be underestimated.

In a multi-authentication schema configuration, when there are several possible authentication methods applied by the S-CSCF, the S-CSCF needs information to decide which method shall be applied. Such information may only be available in REGISTER requests, for example, when IMS AKA is used. Received originating request do not contain such information, so the S-CSCF cannot select the authentication method properly. In this case the S-CSCF has no way to check whether it can trust the received request (e.g. in case of IMS AKA) or it shall authenticate the request (e.g. in case of SIP Digest). This would mean that the S-CSCF cannot provide any originating service until next REGISTER request for the use is received, even if the registration and service related information are stored in the restarted S-CSCF.

According to the invention, authentication related information can be stored in a subscriber server, such as the HSS, from which the authentication related information can be restored to an S-CSCF, for example after S-CSCF restart.

Authentication related information can include, for example, a SIP-Authentication-Scheme, SIP-Digest-Authenticate parameters, Line-Identifier for authentication schema NBA, IP address for authentication schema GIBA, remaining valid authentication vectors for schema IMS-AKA or any other authentication related information needed by an S-CSCF to have knowledge of authentication state of the user.

According to an aspect of the invention, an S-CSCF may not upload any used authentication vector in the HSS or can mark them as used, to make sure that each authentication vector can be used only once.

According to an aspect of the invention, when IMS AKA authentication is used, the authentication schema name can be stored in the HSS. In the IMS AKA, the S-CSCF need not authenticate non-REGISTER requests due to established security association (SA) between the UE and the P-CSCF. If authentication vectors are also stored in HSS, the S-CSCF can update the authentication information in the HSS when a vector is used for re-authentication. The S-CSCF can download the vector from the HSS if the S-CSCF wants re-authentication by a re-REGISTER request.

According to an aspect of the invention, when NBA authentication is used, the authentication schema name and/or Line-Identifier can be stored in the HSS.

According to an aspect of the invention, when GIBA authentication is used, the authentication schema name and/or IP address can be stored in the HSS.

According to an aspect of the invention, when SIP Digest authentication is used, the authentication schema name and/or credentials (HA1) can be stored in the HSS.

According to an aspect of the invention, authentication information can be uploaded to an HSS, stored in the HSS and transmitted to an S-CSCF together with IMS restoration information, for example, with the existing S-CSCF restoration procedure.

Relevant authentication information can be obtained during the registration procedure of a user. During initial registration, the S-CSCF can download authentication information from the HSS via Cx-MAR request to authenticate the IMS user. The S-CSCF can also download authentication information from the HSS via Cx-MAR for re-authentication.

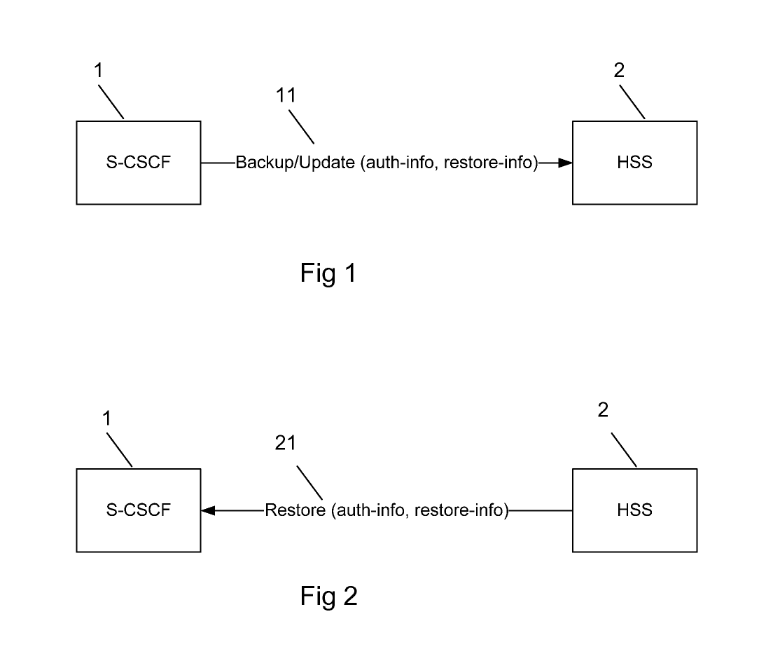

According to an aspect of the invention and shown in FIG. 1, an S-CSCF 1 can backup 11 and/or update 11 authentication information in the HSS 2 during registration process of a user. The backup 11 and/or update 11 can happen together with backing up and updating other S-CSCF restoration information. This would avoid the need for performing a separate Cx transaction.

The authentication information can be embedded in signaling messages in various ways. One possible non-limiting implementation is to include the SIP-Auth-Data-Item AVP, which can contain authentication information, into the existing Restoration-Info AVP.

According to an aspect of the invention, the backup/update 11 of the authentication information can be transmitted to the HSS 2 via the existing Cx-SAR request, or in other known either or new Cx signaling message.

According to an aspect of the invention and shown in FIG. 2, the HSS 2 can return 21 the stored authentication information to an S-CSCF 1 during an S-CSCF restoration process. The authentication information can be transmitted 21 together with other S-CSCF restoration information. Alternatively, the S-CSCF 1 can specifically request the authentication information or the HSS 2 can determine the need for the stored authentication information.

One possible non-limiting implementation is to include the SIP-Auth-Data-Item AVP, which contains the stored authentication information, into the existing Restoration-Info AVP. The authentication information can be transmitted 21 to the S-CSCF 1 via the existing Cx-SAA response, or in other known either or new Cx signaling message.

An example coding of restoration information is given here:

AVP format

Restoration-Info ::=<AVP Header: 649, 10415>

{Path}

{Contact}

[Subscription-Info]

{SIP-Auth-Data-Item}

*[AVP]

SIP-Auth-Data-Item AVP can include one more of following information elements:

[SIP-Item-Number]

[SIP-Authentication-Scheme]

[SIP-Authenticate]

[SIP-Authorization]

[SIP-Authentication-Context]

[Confidentiality-Key]

[Integrity-Key]

[SIP-Digest-Authenticate]

[Framed-IP-Address]

[Framed-IPv6-Prefix]

[Framed-Interface-Id]

[Line-Identifier]

According to an aspect of the invention, authentication information is restored to the same S-CSCF which performed the backup of the authentication information. For example, if the S-CSCF has lost some or all of the authentication information due to a failure but is again able to operate.

According to another aspect of the invention, authentication information is restored to a different S-CSCF than the S-CSCF which performed the backup of the authentication information. For example, if another S-CSCF is assigned for the user after the first S-CSCF which made the backup has failed.

According to an aspect of the invention, authentication information is selectively transmitted to the HSS depending on the used authentication scheme (SIP Digest, IMS AKA, etc) and/or depending on whether single or multiple authentication schemes are supported. The authentication information may be transmitted only if the S-CSCF can benefit from the authentication information later. For example, if only one authentication scheme is used and that scheme is IMS AKA, backing up and restoring the IMS AKA specific authentication information may not be needed.

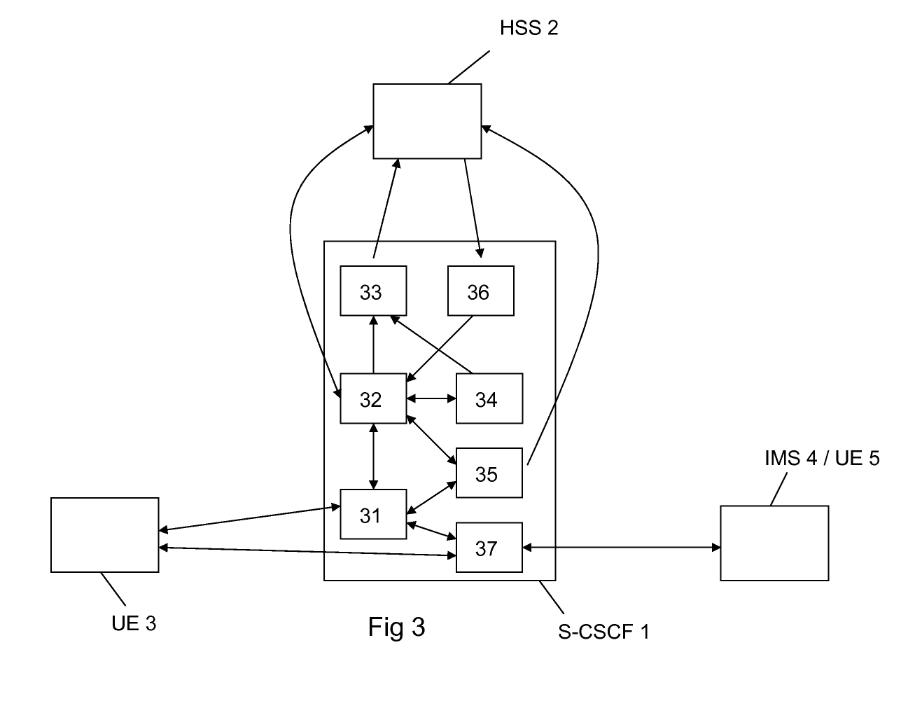

FIG. 3 illustrates an internal structure and functions of an apparatus implementing aspects of the invention. And apparatus, such as, a session control entity (S-CSCF 1) can contain a registering unit 31 configured to register a user 3 to a network. The registration may be performed with SIP REGISTER message received from the user 3. The apparatus can have an authentication unit 32 configured to obtain authentication related information to authenticate the user 3. The authentication unit 32 can communicate with a subscription entity (HSS 2) to retrieve authentication related parameters, for example, using Diameter protocol and/or can obtain authentication information related information from a received signaling message, such as SIP REGISTER request. Authentication information and related parameters can be for example SIP-Authentication-Scheme and/or SIP-Digest-Authenticate parameters. A transmitting unit 33 can be configured to transmitting at least part of the authentication information to the subscription entity (HSS 2) during a registration of the user 3, for example, in Diameter SAR message.

A determining unit 34 can be configured to determining an authentication scheme used for authenticating the user 3, for example based on the information obtained by the authentication unit 32. The transmitting unit 33 can be configured to transmit the authentication information to the subscription entity (HSS 2) depending on the used authentication scheme determined by the determining unit 34, for example, to transmit the authentication information when SIP Digest authentication is used and/or not to transmit the authentication information when IMS AKA authentication used used.

The transmitting unit 33 can be configured to transmit the authentication information over Cx interface with call state control function (S-CSCF) Restoration Information using Diameter protocol.

An update unit 35 can be configured to transmit updated authentication information to the subscription entity (HSS 2), for example, during a re-registration of the user 3.

A receiving unit 36 can be configured to receive authentication information from the subscription entity (HSS 2) during a restoration process, for example, in Diameter SAA message.

A session handling unit 37 can be configured to handle session signaling between the user 3 and the other party of communication (IMS 4/UE 5), for example, according to SIP protocol.

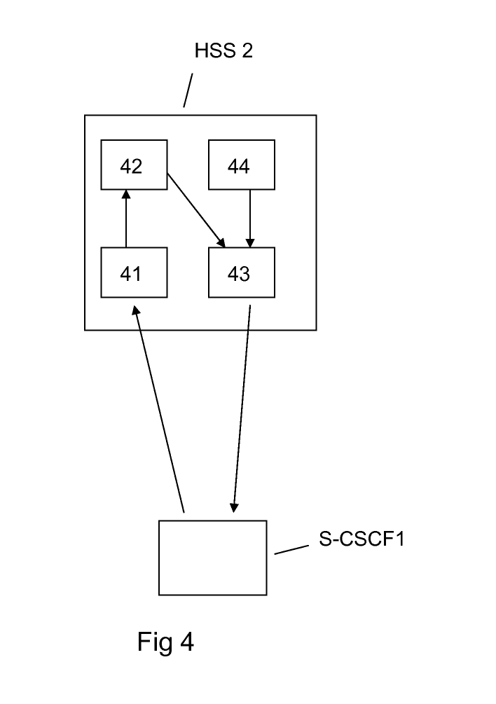

FIG. 4 illustrates an internal structure and functions of another apparatus implementing aspects of the invention. An apparatus, such as, a subscription entity (HSS 2) can contain a receiving unit 41 configured to receive from a session control entity 1 authentication information, for example, during a registration of a user 3 in Diameter signalling (e.g. SAR). A memory unit 42 can be configured to store the received authentication information. The memory unit 42 can be configured to store the authentication information together with IMS restoration information an/or associated with an identity of the user 3 an/or with an implicit registration set.

A transmitting unit 43 can be configured to transmit the authentication information to a session control entity (S-CSCF), which can be the same session control entity 1 from which the authentication information was received or another session control entity which is now serving the user.

A determining unit 44 can be configured to determine if another session control entity is assigned to serve the user 3, which can cause the transmitting unit 43 to transit the authentication information to that session control entity.

All units described above in relation to FIGS. 3 and 4 may be implemented for example using microprocessors, chips and/or other electrical components and/or by software.

A subscription entity and a session control entity may be physically implemented in a switch, router, server or other hardware platform or electronic equipment which can support data transmission and processing tasks, or can be implemented as a component of other existing device.

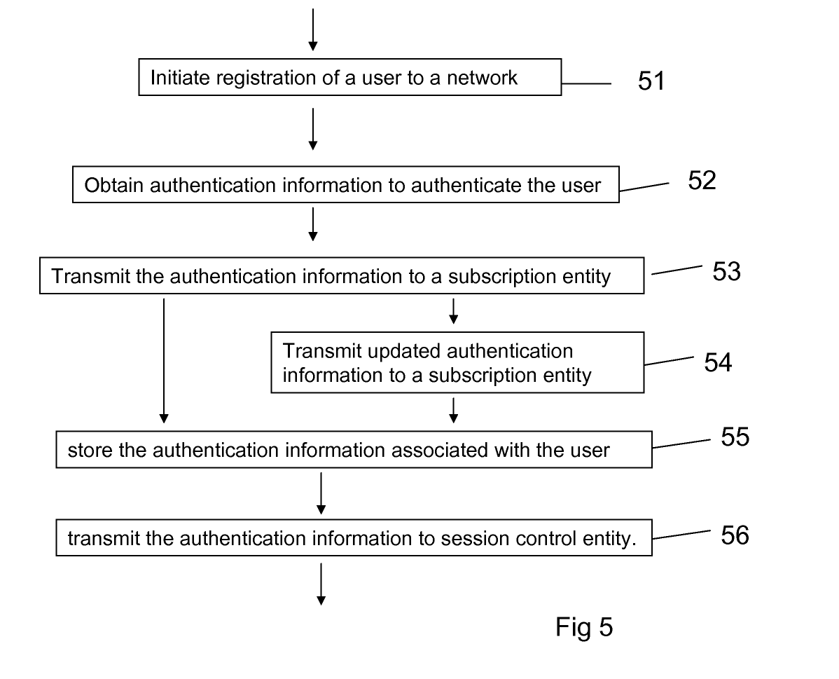

FIG. 5 shows an example process for implementing aspects of the invention. A registration process 51 can be initiated to register a user to a network. For the registration, authentication related parameters can be retrieved 52. At least some authentication information can be transmitted 53 to a subscription entity, for example, during the registration process. Some, for example, changed or updated authentication information can be transmitted 54 to the subscription entity later, for example during re-authentication or re-registration process of the user. The changed or updated authentication information can replace partly or fully the previously stored authentication information. The authentication information transmitted 53, 54 can be stored 55, for example together with S-CSCF restoration information in the HSS and/or associated with an identity of the user. The stored authentication information can be transmitted 56 to the entity which originally transmitted the authentication information for storing or to another entity.

For the purpose of the present invention as described herein above, it should be noted that

an access technology via which signaling is transferred to and from a network element or node may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,

usable access networks may be any device, apparatus, unit or means by which a station, entity or other user equipment may connect to and/or utilize services offered by the access network; such services include, among others, data and/or (audio-) visual communication, data download etc.;

a user equipment may be any device, apparatus, unit or means by which a system user or subscriber may experience services from an access network, such as a mobile phone, personal digital assistant PDA, or computer;

method steps likely to be implemented as software code portions and being run using a processor at a network element or terminal (as examples of devices, apparatuses and/or modules thereof, or as examples of entities including apparatuses and/or modules therefor), are software code independent and can be specified using any known or future developed programming language as long as the functionality defined by the method steps is preserved;

generally, any method step is suitable to be implemented as software or by hardware without changing the idea of the invention in terms of the functionality implemented;

method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;

devices, apparatuses, units or means can be implemented as individual devices, apparatuses, units or means, but this does not exclude that they are implemented in a distributed fashion throughout the system, as long as the functionality of the device, apparatus, unit or means is preserved,

an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

The invention is not limited to authentication information handling in the IMS network(s), but may also be applied in other type of networks having similar kind of subscription entity able to backup, store and transmit information. Functions of the subscription entity and session control entity described above may be implemented by code means, as software, and loaded into memory of a computer.

1. A session control entity (1), comprising means for registering a user to a network, means for obtaining authentication information for the user, and, means for transmitting the authentication information to a subscription entity of the network during a registration of the user.

2. A session control entity of claim 1, wherein the transmitting means is configured to transmit the authentication information with call state control function (S-CSCF) Restoration Information.

3. A session control entity of claim 1, further comprising means for transmitting updated authentication information to the subscription entity of the network.

4. A session control entity of claim 1, wherein the authentication information is transmitted in {SIP-Auth-Data-Item} Attribute-Value-Pair (AVP).

5. A session control entity of claim 1, wherein the authentication information comprises at least one of SIP-Authentication-Scheme and SIP-Digest-Authenticate parameters.

6. A session control entity of claim 1, further comprising means for determining an authentication scheme used for authenticating the user and wherein the means for transmitting is configured to transmit the authentication information to the subscription entity depending on the used authentication scheme.

7. A session control entity of claim 6, wherein the means for transmitting is configured to at least one of:
transmit the authentication information when the used authentication scheme comprises SIP Digest authentication, and,
not to transmit the authentication information when the used authentication scheme comprises IMS AKA.

8. A session control entity of claim 1, further comprising means for receiving the authentication information from the subscription entity of the network.

9. A subscription entity, comprising:
means for receiving from a first session control entity authentication information during a registration of a user, means for transmitting the authentication information to the first or a second session control entity.

10. A subscription entity of claim 9, further comprising means for determining that a second session control entity is assigned to serve the user, and wherein the authentication information is transmitted to the second session control entity.

11. A subscription entity of claim 9, further comprising means for storing the authentication information.

12. A subscription entity of claim 11, wherein the means for storing is configured to store the authentication information at least one of:
associated with an identity of the user,
together with or as part of call state control function restoration information.

13. A subscription entity of claim 11, further comprising means for replacing at least part the authentication information with updated authentication information received from the first session control entity.

14. A method of transmitting authentication information, comprising
transmitting, by a first session control entity, authentication information to a subscription entity during a registration of a user, and,
transmitting, by the subscription entity, the authentication information to the first or a second session control entity assigned to serve the user.

15. A method of claim 14 further comprising storing the authentication information at the subscription entity as part of call state control function restoration information.

16. A method of transmitting authentication information, comprising
initiating registration of a user to a network, obtaining authentication information to authenticate the user, and,
transmitting the authentication information subscription entity of the network during the registration of the user.

17. A method of claim 16, further comprising determining an authentication scheme used for authenticating the user and wherein the transmitting comprises to transmit the authentication information the subscription entity depending on the used authentication scheme.

18. A method of transmitting authentication information, comprising
receiving from a first session control entity authentication information during a registration of a user, and
transmitting the authentication information to the first or a second session control entity.

19. A computer program product comprising code means adapted to produce steps of claim 14 when loaded into the memory of a computer.
